(19) United States
(12) Patent Application Publication
(10) Pub. No.: US 2009/0315879 A1
(43) Pub. Date: Dec. 24, 2009

(54) Plasma display device

(76) Inventor: Jeong-Nam Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/457,459

(22) Filed: Jun. 11, 2009

(30) Foreign Application Priority Data
Jun. 12, 2008 (KR) 10-2008-0055266

(51) Int. Cl. G09G 3/28; G09G 5/00

(52) U.S. Cl. 345/214; 345/60

(57) ABSTRACT

A plasma display device includes a plasma display panel (PDP), the PDP including sustain electrodes, scan electrodes, and address electrodes disposed in correspondence to a plurality of discharge cells to selectively drive at least one discharge cell of the plurality of discharge cells, a chassis base supporting the PDP, at least one printed circuit board on the chassis base, the chassis base being between the printed circuit board and the PDP, a flexible printed circuit (FPC) connecting the scan electrodes to the printed circuit board, the FPC including a switch configured to control the scan electrodes, a conductor on the FPC, the conductor overlapping the switch, and a stiffener on the conductor to dissipate heat generated from the switch.

### BACKGROUND OF THE INVENTION

1. Field of the Invention

Exemplary embodiments relate to a plasma display device. Particularly, exemplary embodiments relate to a plasma display device having a flexible printed circuit (FPC) with a switch and configured to have improved heat dissipation performance and ground stability of the switch while electrically insulating it.

2. Description of the Related Art

Generally, a plasma display device may include a plasma display panel (PDP) displaying an image, a chassis base supporting the PDP, and a plurality of printed circuit boards mounted on the chassis base and connected to the PDP.

The PDP may generate plasma via a gas discharge, and may excite phosphors using vacuum ultra-violet (VUV) rays emitted from the plasma. The PDP may display an image using visible light of red (R), green (G), and blue (B) colors that may be generated while the excited phosphors are being stabilized.

For the gas discharge, the PDP may include address electrodes and display electrodes (for example a sustain electrode and a scan electrode), which may intersect each other to correspond to discharge cells. The address electrodes, the sustain electrodes, and the scan electrodes may be connected to corresponding printed circuit boards via FPCs.

The printed circuit boards may include, e.g., a sustain board controlling the sustain electrodes, a scan board controlling the scan electrodes, and an address buffer board controlling the address electrodes. For example, the scan board may be connected, e.g., using a chip on film (COF) scheme or a tape carrier package (TCP) scheme, to independently control the scan electrodes.

When using a COF or TCP, the conventional FPC may include a switch, e.g., a scan integrated circuit (IC), and a stiffener to protect the switch. However, when applying voltage, e.g., to the scan IC in the conventional FPC, a scan low voltage instead of 0 V may be grounded to the stiffener. Accordingly, the COF or TCP may cause electrical problems, e.g., insulating defects of the scan IC via the stiffener, a heat dissipation defect of the scan IC, and the occurrence of noise due to instability of the scan low voltage ground.

For example, the insulation defect of the scan IC via the stiffener may cause electrical damage due to electric shock or contact with another ground. The heat dissipation defect of the scan IC may damage the scan IC. The noise may make the ground unstable, thereby causing a malfunction of the scan IC.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments are therefore directed to a plasma display device having a FPC, which substantially overcomes one or more of the shortcomings and disadvantages of the related art.

It is therefore a feature of an exemplary embodiment to provide a plasma display device with a FPC configured to have improved heat dissipation function of a switch therein.

It is another feature of an exemplary embodiment to provide a plasma display device with a FPC configured to have improved ground stability of a switch therein.

It is yet another feature of an exemplary embodiment to provide a plasma display device with a FPC configured to have improved electrical insulation of a switch therein.

At least one of the above and other features may be realized by providing a plasma display device, including a PDP with a sustain electrode, a scan electrode, and an address electrode that are disposed in correspondence to a plurality of discharge cells to selectively drive at least one discharge cell of the plurality of discharge cells, a chassis base supporting the PDP, at least one printed circuit board being mounted on the chassis base at the opposite side of the PDP, a FPC mounted with a switch that connects the scan electrode to the printed circuit board and controls the scan electrode, a conductor on the FPC overlapping the switch, and an insulating stiffener on the conductor to dissipate heat generated from the switch.

The conductor may be formed as a film, a tape, or a sheet. The stiffener may be formed of an insulating material. The stiffener may include aluminum nitrate (AlN).

The switch and the FPC may be grounded to the conductor. The conductor and switch may be on opposite surfaces of the FPC. The conductor may be between the FPC and the stiffener. The conductor may be longer and wider than the stiffener. The conductor may completely overlap the switch.

The stiffener having the conductor, which is built in a groove formed therein, may be attached to the FPC. The conductor may completely fill the groove. Outer surfaces of the conductor and stiffener may be substantially coplanar and facing the FPC. The FPC may be formed as a COF or a TCP. The switch may be a scan IC.

At least one of the above and other features may be realized by providing a plasma display device, including a FPC connecting a scan electrode of a PDP being mounted on a front of a chassis base and a scan board being mounted on a rear of the chassis base and mounted with a scan IC controlling the scan electrode, a conductor being attached to the flexible printed circuit in correspondence to the scan IC, and an insulator being attached to the conductor to dissipate the heat generated from the scan IC.

The scan IC and the FPC may be grounded to the conductor. The insulator may include AlN. The insulator having the conductor, which is built in a groove formed therein, may be attached to the FPC.

### BRIEF DESCRIPTION OF THE DRAWINGS

The above and other features and will become more apparent to those of ordinary skill in the art by describing in detail exemplary embodiments with reference to the attached drawings, in which:

FIG. 1 illustrates an exploded perspective view of a plasma display device according to an exemplary embodiment;

FIG. 2 illustrates an unfolded front view of a connection of a PDP, a sustain board, and a scan board to a FPC in FIG. 1;

FIG. 3 illustrates an enlarged perspective view of a connection of a PDP and a scan board to a FPC in FIG. 1;

FIG. 4 illustrates an exploded perspective view of an FPC, a stiffener, and a heat sink of FIG. 1;

FIG. 5 illustrates a cross-sectional view along line V-V of FIG. 4;

FIG. 6 illustrates an exploded perspective view of an FPC, a stiffener, and a heat sink in a plasma display device according to another exemplary embodiment; and

FIG. 7 illustrates a cross-sectional view along line VII-VII of FIG. 6.

### DETAILED DESCRIPTION OF THE EMBODIMENTS

Korean Patent Application No. 10-2008-0055266 filed on Jun. 12, 2008, in the Korean Intellectual Property Office, and entitled: “Plasma Display Device,” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the terms “a” and “an” are open terms that may be used in conjunction with singular items or with plural items.

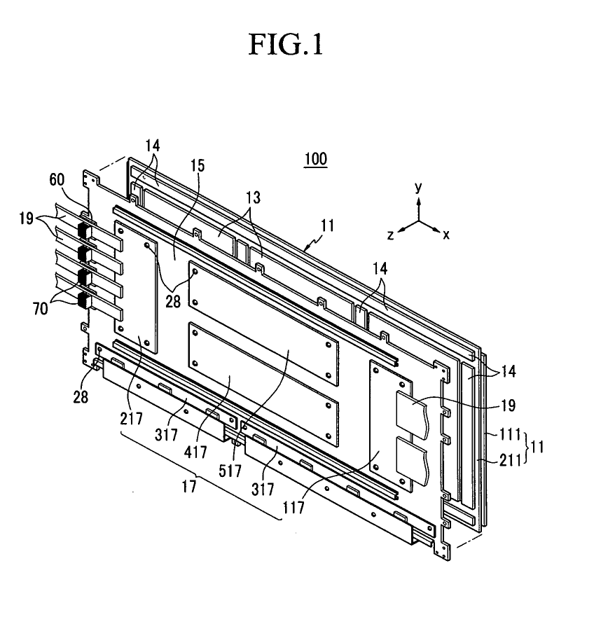

FIG. 1 illustrates an exploded perspective view of a plasma display device 100 according to an exemplary embodiment.

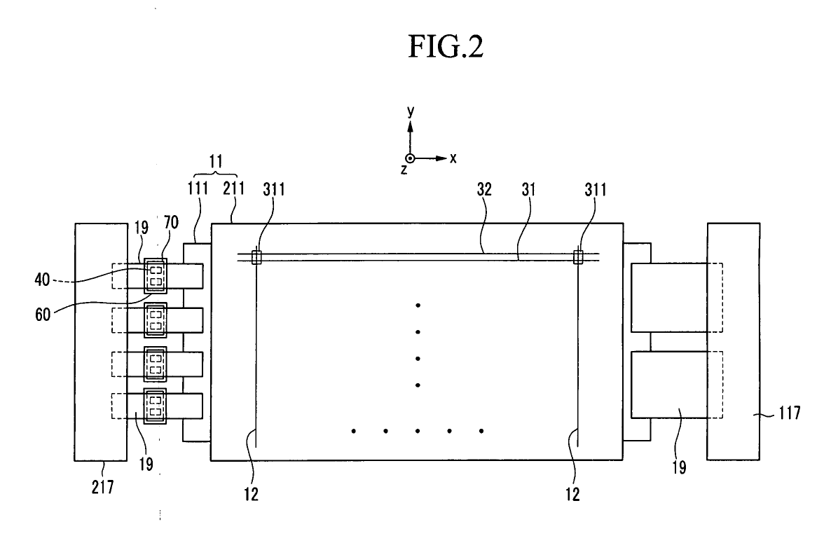

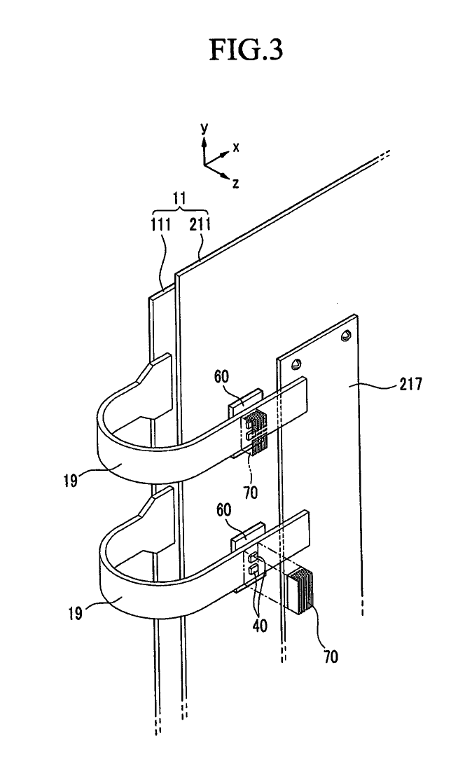

Referring to FIG. 1, the plasma display device 100 may include a PDP 11 displaying an image using a gas discharge, a heat dissipation sheet 13, a chassis base 15, a plurality of printed circuit boards 17, and a FPC 19. The PDP 11 may include front and rear substrates 111 and 211 parallel to each other and having a discharge space therebetween for generating the gas discharge, as will be explained in more detail below with reference to FIGS. 2-3.

Exemplary embodiments of the present invention relate to a structural configuration of elements with respect to the PDP 11, and thus a detailed description of the PDP 11 will be omitted herein.

FIG. 2 illustrates an unfolded front view of a connection of the PDP 11, a sustain board 117, and a scan board 217 to the FPC 19. FIG. 3 illustrates a partially enlarged perspective view of a connection of the PDP 11 to the scan board 217 via the FPC 19.

Referring to FIGS. 2 and 3, the PDP 11 may include a plurality of discharge cells 311 in the discharge space between the front and rear substrates 111 and 211. The PDP 11 may further include a plurality of electrodes between the front and rear substrates 111 and 211. For example, as illustrated in FIG. 2, a sustain electrode 31, a scan electrode 32, and an address electrode 12 may be disposed to correspond to the discharge cell 311.

The address electrodes 12 and the scan electrodes 32 may intersect each other in correspondence to the discharge cell 311, so a discharge therebetween may select a discharge cell 311 to be turned on. The sustain electrodes 31 and the scan electrodes 32 may be disposed in parallel with each other in correspondence to the discharge cell 311, so a discharge therebetween may realize an image in the selected discharge cell 311. The address electrodes 12 may extend along a first direction, e.g., along a y-axis direction. The sustain electrodes 31 and the scan electrodes 32 may extend along a second direction, e.g., along a x-axis direction, crossing the first direction.

Referring again to FIG. 1, the heat dissipation sheet 13 may be disposed at the rear of the PDP 11, i.e., on the rear substrate 211, to diffuse heat generated in the PDP 11 during the gas discharge. The heat may be diffused from the PDP 11 toward the plane of the PDP 11.

The chassis base 15 may be attached to the rear of the PDP 11, i.e., on the rear substrate 211, using a double-sided adhesive tape 14, with the heat dissipation sheet 13 therebetween. The chassis base 15 may support the PDP 11.

The printed circuit boards 17 may be mounted on a rear surface of the chassis base 15, and may be electrically connected to the PDP 11. The printed circuit board 17 may drive the PDP 11.

The printed circuit boards 17 may be disposed on a plurality of bosses (not shown) formed on the chassis base 15, to combine the bosses with setscrews 28. The printed circuit boards 17 may include a plurality of circuit boards, and may perform a plurality of functions for driving the PDP 11. For example, the printed circuit boards 17 may include a sustain board 117 controlling the sustain electrodes 31, a scan board 217 controlling the scan electrodes 32, and an address buffer board 317 controlling the address electrodes 12.

Also, the printed circuit boards 17 may include an image processing/controlling board 417 and a power supply board 517. The image processing/controlling board 417 may receive an image signal from an external source, and may generate and apply corresponding control signals for driving the address electrodes 12, the sustain electrodes 31, and the scan electrodes 32 via respective circuit boards. The power supply board 517 may supply power to drive the sustain board 117, scan board 217, address buffer board 317, and image processing/controlling board 417.

The FPC 19 may connect the printed circuit boards 17 to the PDP 11. For example, the FPC 19 may connect the sustain board 117 to the sustain electrodes 31 in the PDP 11. Similarly, the FPC 19 may connect the scan board 217 to the scan electrodes 32 and the address buffer board 317 to the address electrodes 12. For example, as illustrated in FIG. 3, a first end of the FPC 19 may be attached to the scan board 217 on the rear surface of the chassis base 15, and a second end of the FPC 19 may be bent around an edge of the rear substrate 211 of the PDP 11 to be attached to the scan electrodes 32 between the front and rear substrates 111 and 211 of the PDP 11. As further illustrated in FIG. 3, the FPC 19 may include a switch 40 and a heat sink 70.

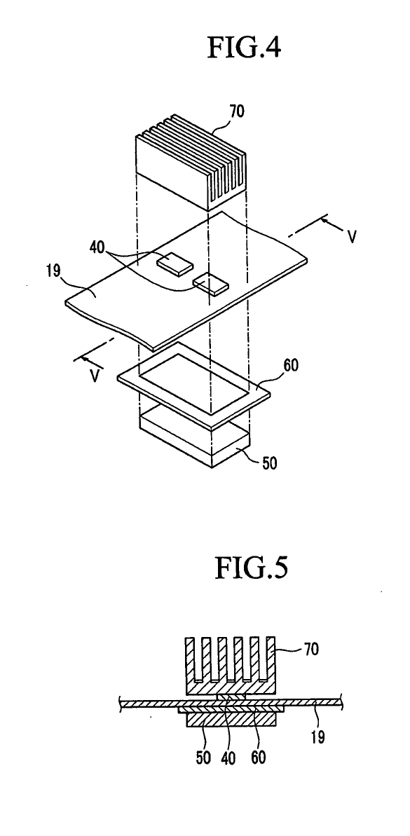

FIG. 4 illustrates an exploded perspective view of a portion of the FPC 19 with the switch 40 and heat sink 70. FIG. 5 illustrates a cross-sectional view along line V-V of FIG. 4.

Referring to FIGS. 4 and 5, the FPC 19 may be mounted with the switch 40 that may generate a signal to control the scan electrodes 32. For example, the FPC 19 may be formed as a COF or a TCP that is mounted with the switch 40. The switch 40 may be mounted on a first surface of the FPC, i.e., a surface facing away from the PDP 11. For example, the switch 40 may be a scan IC. It is noted that for convenience of description only the terms “switch 40” and “scan IC 40” may be used hereinafter interchangeably.

As illustrated in FIGS. 4 and 5, the FPC 19 may include a stiffener 50 and a conductor 60 on one of its surfaces. The stiffener 50 and conductor 60 may be configured between the FPC 19 and the PDP 11.

The stiffener 50 may be formed of an insulating material in correspondence to the scan IC 40. Accordingly, the stiffener 50 may be an insulator with electrical insulating properties and good heat transfer properties. For example, the stiffener 50 may be formed of, e.g., aluminum nitrate (AlN).

The stiffener 50 may be attached to a second surface of the FPC 19, i.e., a surface opposite the first surface of the FPC 19, so the stiffener 50 and scan IC 40 may be on opposite surfaces of the FPC 19. The stiffener 50 may have any suitable structure and may overlap the scan IC 40 to maintain the shape of the FPC 19 and protect the scan IC 40 from an external impact. For example, as illustrated in FIGS. 4 and 5, the stiffener 50 may have uniform thickness and width, so cross-sections of the stiffener 50 in horizontal and vertical planes may have rectangular shapes. In this respect, it is noted that a vertical plane refers to a plane crossing the scan IC 40 along line V-V in FIG. 4, and a horizontal plane refers to a plane parallel to a major surface of the scan IC 40.

Since the stiffener 50 overlaps, e.g., completely overlaps, the scan IC 40 and has electrical insulating properties, the scan IC 40 may be electrically insulated from other components of the plasma display device 100 via the stiffener 50. Further, the stiffener 50 may exhibit good heat transfer properties and may facilitate heat dissipation from the scan IC 40.

The conductor 60 may be positioned between the scan IC 40 and the stiffener 50, as illustrated in FIGS. 4 and 5. In detail, the stiffener 50 may be attached to the FPC 19 by interposing the conductor 60 therebetween, e.g., the conductor 60 may be directly between the stiffener 50 and the FPC 19. The conductor 60 may have larger length and width than length and width of the stiffener 50, i.e., sides of the conductor 60 and stiffener 50 along length and width directions may define the horizontal plane. The conductor 60 may overlap, e.g., completely overlap, the stiffener 50.

The conductor 60 may have a substantially flat structure, e.g., formed as a film, a tape, or a sheet. In detail, the conductor 60 may have any suitable structure or shape to provide a surface contact with each of the FPC 19 and the stiffener 50. In other words, if the conductor 60 is a film, a tape, or a sheet, one surface of the conductor 60 may be in surface contact with the stiffener 50 and the other surface, i.e., opposite surface, of the conductor 60 may be in surface contact with the FPC 19.

Accordingly, the stiffener 50 may be thermally connected to the FPC 19 via the conductor 60. In other words, positioning of the conductor 60 between the stiffener 50 and the FPC 19 may improve transfer of heat generated in the scan IC 40 to the stiffener 50 via the conductor 60, so heat dissipation efficiency may increase.

Also, the scan IC 40 and the FPC 19 may be grounded to the conductor 60. In detail, the scan IC 40 may form a stable ground upon driving, so noise may be reduced. Accordingly, the configuration of the stiffener 50 with respect to the FPC 19 and the conductor 60 may improve ground performance of the scan IC 40.

The ground used in the exemplary embodiment denotes ground for the scan IC 40 which is a switch, instead of a set ground for the entire plasma display device 100. The ground of the scan IC 40 may operate in a floating state, i.e., the ground of the scan IC 40 may be a floating ground. For example, the ground of the scan IC 40 may include a power output ground, a logic ground, and a substrate ground. Accordingly, the ground used in the exemplary embodiment may denote at least one of the above grounds.

As illustrated in FIGS. 3-5, the FPC 19 may further include the heat sink 70 in order to dissipate the heat generated from the scan IC 40 mounted on the FPC 19. The heat sink 70 may be on the first surface of the FPC 19 and may be attached to the scan IC 40. In other words, the scan IC 40 may be between the heat sink 70 and the FPC 19.

Accordingly, heat generated from the scan IC 40 may be dissipated via the heat sink 70 and the stiffener 50. For example, the heat generated in the scan IC 40 may be primarily dissipated via the heat sink 70 from a first surface of the scan IC 40, and may be additionally dissipated via the conductor 60 and the stiffener 50 from a second surface of the scan IC 40, i.e., a surface opposite the first surface.

Hereinafter, another exemplary embodiment will be described. Same or similar descriptions to the previous exemplary embodiment will be omitted and only different portions will be described in detail herein. In other words a plasma display device described hereinafter may be substantially the same as the plasma display device 100 described previously with reference to FIGS. 1-5, with the exception of having a different configuration of a stiffener and a conductor with respect to an FPC.

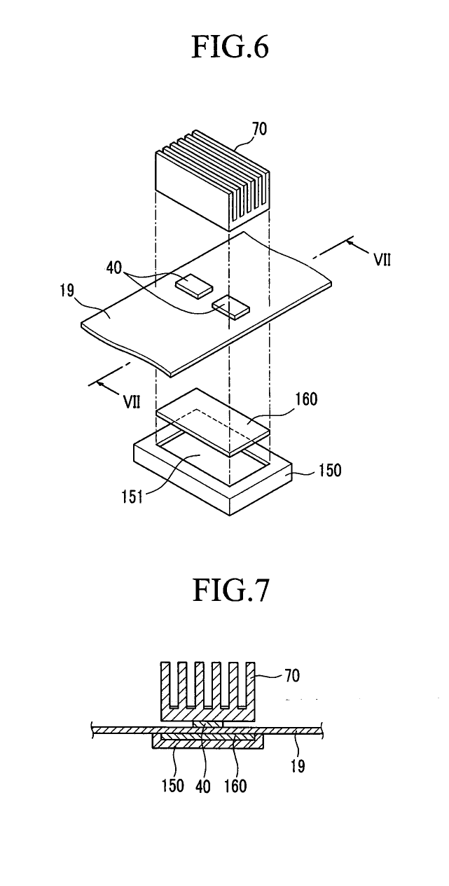

FIG. 6 illustrates an exploded perspective view of an FPC, a stiffener, and a heat sink in a plasma display device according to the other exemplary embodiment. FIG. 7 illustrates a cross-sectional view along line VII-VII of FIG. 6.

Referring to FIGS. 6 and 7, a stiffener 150, which has a groove 151 formed in one side facing the FPC 19, and a conductor 160 built in the groove 151 may be attached to one surface of the FPC 19. As illustrated in FIGS. 6 and 7, a portion of the stiffener 150 may be removed to form a cavity, e.g., a rectangular cavity, having a predetermined depth. The cavity may define the groove 151, and the conductor 160 may be formed in the groove 151. For example, the conductor 160 may completely fill the groove 151.

As further illustrated in FIG. 7, surfaces of the stiffener 150 and conductor 160 facing the FPC 19 may be substantially coplanar, i.e., a thickness of the conductor 160 may substantially equal the predetermined depth of the groove 151. In other words, one surface of the conductor 160 may be connected to, e.g., in direct touch with, the FPC 19, and the remaining five surfaces of the conductor 160 may be connected to the stiffener 150 in the groove 151. Therefore, the conductor 160 may quickly transfer heat generated from the scan IC 40 to the stiffener 150. Accordingly, the heat dissipation performance of the scan IC 40 may be further improved. Further, positioning of the stiffener 150 on the FPC 19, e.g., portions of the stiffener 150 in direct contact with the FPC 19, may improve insulation and ground performance of the scan IC 40.

The groove 151 formed in the stiffener 150 may facilitate attachment of the conductor 160 to the FPC 19 in a stable structure. Further, the groove 151 may maintain the shape of the conductor 160 between the FPC 19 and the stiffener 150, and may reduce deterioration of the ground performance of the scan IC 40 over time. For example, if the conductor 160 is formed of a film and leaks, positioning of the conductor 160 in the groove 151 may prevent or substantially minimize leakage between the FPC 19 and the stiffener 150, thereby preventing deterioration of ground performance.

According to exemplary embodiments, a conductor may be attached to a FPC, e.g., having a COF or a TCP structure, to overlap a switch thereon, and a stiffener may be attached to the conductor. Therefore, the switch may be electrically insulated via the stiffener, and heat dissipation performance of the switch to the stiffener may be improved via the conductor therebetween.

Further, since the switch and the FPC may be grounded to the conductor, ground stability of the switch may be improved when applying a drive voltage to the switch. Therefore, it may be possible to reduce noise occurring in the switch, e.g., scan IC, and to prevent malfunction of the switch.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel (PDP), the PDP including sustain electrodes, scan electrodes, and address electrodes disposed in correspondence to a plurality of discharge cells to selectively drive at least one discharge cell of the plurality of discharge cells;
a chassis base supporting the PDP;
at least one printed circuit board on the chassis base, the chassis base being between the printed circuit board and the PDP;
a flexible printed circuit (FPC) connecting the scan electrodes to the at least one printed circuit board, the FPC including a switch configured to control the scan electrodes;
a conductor on the FPC, the conductor overlapping the switch; and
a stiffener on the conductor to dissipate heat generated from the switch.

2. The plasma display device as claimed in claim 1, wherein the conductor has a structure of a film, a tape, or a sheet.

3. The plasma display device as claimed in claim 1, wherein the stiffener includes an insulating material.

4. The plasma display device as claimed in claim 3, wherein the stiffener includes aluminum nitrate (AlN).

5. The plasma display device as claimed in claim 1, wherein the switch and FPC are grounded to the conductor.

6. The plasma display device as claimed in claim 1, wherein the conductor and switch are on opposite surfaces of the FPC.

7. The plasma display device as claimed in claim 1, wherein the conductor is between the FPC and the stiffener.

8. The plasma display device as claimed in claim 7, wherein the conductor is longer and wider than the stiffener.

9. The plasma display device as claimed in claim 1, wherein the conductor completely overlaps the switch.

10. The plasma display device as claimed in claim 1, wherein the stiffener includes a groove, the conductor being in the groove.

11. The plasma display device as claimed in claim 10, wherein the conductor completely fills the groove.

12. The plasma display device as claimed in claim 11, wherein outer surfaces of the conductor and stiffener are substantially coplanar and facing the FPC.

13. The plasma display device as claimed in claim 1, wherein the switch is a scan IC.

14. The plasma display device as claimed in claim 1, wherein the FPC has a chip on film (COF) structure or a tape carrier package (TCP) structure.

15. A plasma display device, comprising:
a flexible printed circuit (FPC) connecting scan electrodes of a plasma display panel (PDP) to a scan board, the FPC including a scan IC controlling the scan electrodes;
a conductor on the FPC, the conductor being attached to the FPC in correspondence with the scan IC; and
an insulator on the conductor to dissipate heat generated from the scan IC.

16. The plasma display device as claimed in claim 15, wherein the scan IC and the FPC are grounded to the conductor.

17. The plasma display device as claimed in claim 16, wherein the insulator includes nitride aluminum (AlN).

18. The plasma display device as claimed in claim 15, wherein the insulator includes a groove, the conductor being in the groove.
